(19) United States
(12) Patent Application Publication
(10) Pub. No.: US 2013/0138552 A1
(43) Pub. Date: May 30, 2013

(54) UNIFIED CHARGING AND CREDIT SYSTEM

(71) Applicants: Ilya Oskolkov, Moscow (RU); Rodion Shishkov, St. Petersburg (RU)

(72) Inventors: Ilya Oskolkov, Moscow (RU); Rodion Shishkov, St. Petersburg (RU)

(73) Assignee: RAWLLIN INTERNATIONAL INC., Tortola (VG)

(21) Appl. No.: 13/305,284

(22) Filed: Nov. 28, 2011

(51) Int. Cl. G06Q 20/24; G06Q 40/02

(52) U.S. Cl. 705/38; 705/44

(57) ABSTRACT

Technologies are generally described for systems and methods effective to create and use a unified charging system that provides instant loans in a networking environment. In an example, a loan can be provided when a payment at an online shopping site, such as an online shopping portal, is rejected due to insufficient funds. The loan can be automatic, or the loan can be provided in response to acceptance of a loan offer. In another example, pre-approved credit can be used to pay at an online shopping site when the cash and credit accounts associated with a virtual charging account have insufficient funds to complete the transaction. The payment can consist of a portion, or all of the pre-approved credit. The pre-approved credit can be granted on request, or can be automatically provided based on an analysis of open source information about the holder of the virtual charging account.

### TECHNICAL FIELD

This disclosure relates generally to a unified charging and credit and loan system in a networked device environment.

### BACKGROUND

Online shopping has greatly increased in recent years, propelled by the ubiquitous use of mobile devices, and rapidly expanding Internet use. A plethora of services have arisen to simplify the shopping experience by offering services to consolidate the different type of payments that all the different online shopping sites require. Some services offer universal charge accounts that can be used across a wide range of websites. Others offer e-wallet systems to simplify the checkout procedures.

The current e-wallet systems can have stored bank account and credit card information that can be used when shopping online to streamline the consumer experience. These e-wallet systems are, however, still subject to the limitations placed upon traditional cash, debit, and credit accounts. For example, when the balances of the cash and debit accounts are zero, or the credit cards are maxed out, the e-wallet system will be inoperative. It is possible to add additional credit cards to the e-wallet system, but current systems are still reliant on the constituent components of the e-wallet system being solvent. It is not currently possible to provide a seamless service that allows a customer to continue shopping even if the elements of the e-wallet system are insolvent.

The above-described deficiencies of conventional e-wallet and charging systems are merely intended to provide an overview of some of problems of current technology, and are not intended to be exhaustive. Other problems with the state of the art, and corresponding benefits of some of the various non-limiting embodiments described herein, may become further apparent upon review of the following detailed description.

### SUMMARY

In various non-limiting embodiments, systems and methods are provided to use a unified charging system that can provide instant loans in a networking environment. In an example embodiment, a method comprises receiving an indication of a checkout at a shopping site and receiving a selection of at least one cash and credit account affiliated with a virtual charging account for payment. The method can also include receiving an indication of a rejection of payment, and providing a loan to cover the payment at the shopping site in response to the receiving the indication of the rejection of payment.

In another example embodiment, a system comprises an initialization component configured to receive an indication of a checkout at a shopping site and a selection of at least one cash and credit accounts affiliated with a virtual charging account for payment at the shopping site. The system can also comprise a verification component configured to determine that the at least one cash and credit account has an insufficient balance to make the payment and a loan component configured to provide a loan to make the payment at the shopping site in response to the insufficient balance.

In another example embodiment, a computer readable storage medium comprising computer executable instructions that, in response to execution, cause a computing system to perform operations, comprising receiving an indication of a checkout at a shopping site and receiving a selection of at least one cash and credit account affiliated with a virtual charging account for payment. The operations can also include receiving an indication of a rejection of payment, and providing a loan to cover the payment at the shopping site in response to receiving the indication of the rejection of payment.

In another example embodiment, a method comprises displaying a list of cash and credit accounts affiliated with a virtual charging account in response to receiving an indication of a checkout at a shopping site, displaying pre-approved credit associated with the virtual charging account. The method can also comprise selecting at least one of the cash and credit accounts affiliated with the virtual charging account and a portion of the pre-approved credit and transferring payment from the at least one cash and credit accounts and the pre-approved credit to the shopping site.

In another example embodiment, a system can comprise a display component configured to display a list of cash and credit accounts and pre-approved credit affiliated with a virtual charging account in response to reception of an indication of a checkout at a shopping site and a selection component configured to select at least one of the cash and credit accounts and a portion of the pre-approved credit affiliated with the virtual charging account. The system can also comprise a payment component configured to pay a balance at the shopping site using the at least one cash and credit accounts and the pre-approved credit.

These and other embodiments are described in more detail below.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram illustrating an example, non-limiting embodiment of a unified charging system that can provide instant loans;

FIG. 2 is a block diagram illustrating an example, non-limiting embodiment of a system that checks the balance and credit limits of cash and credit accounts associated with a virtual charging account;

FIG. 3 is a block diagram illustrating an example, non-limiting embodiment of a system that receives an indication of insufficient balance from a credit card issuer and a shopping site;

FIG. 4 illustrates a flow diagram of an example, non-limiting embodiment of a method for providing an instant loan to cover a payment at a shopping site;

FIG. 5 is a block diagram illustrating an example, non-limiting embodiment of a system that can make a payment at a shopping site using linked cash or credit accounts and pre-approved credit;

FIG. 6 is a block diagram illustrating an example, non-limiting embodiment of a system for displaying the balance of cash and credit accounts affiliated with a virtual charging account;

FIG. 7 illustrates a flow diagram of an example, non-limiting embodiment of a method for shopping online and paying using a virtual charging account and pre-approved credit;

FIG. 8 illustrates a flow diagram of an example, non-limiting embodiment of a set of computer-readable instructions for providing an instant loan to cover a payment at a shopping site;

FIG. 9 is a block diagram illustrating an example networking environment that can be employed in accordance with the claimed subject matter;

FIG. 10 is a block diagram illustrating an example computing device that is arranged for at least some of the embodiments of the claimed subject matter;

FIG. 11 illustrates an example of a mobile device that can process content in accordance with the claimed subject matter.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

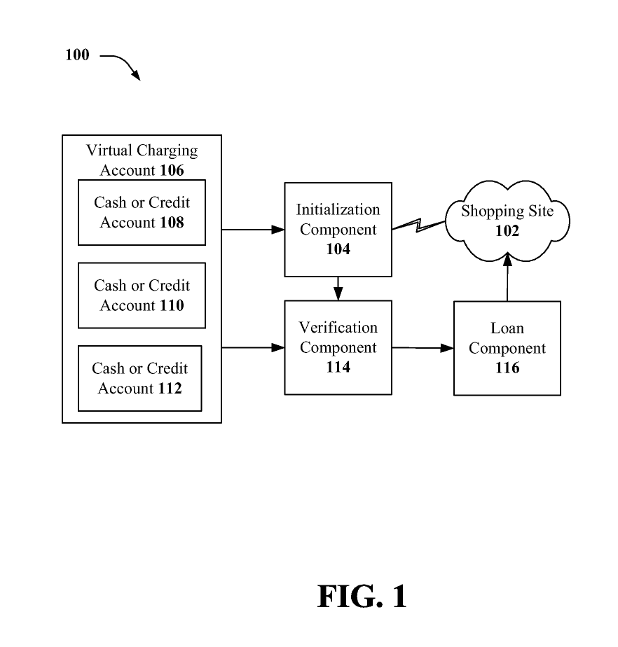

Turning now to FIG. 1, a block diagram illustrating an example, non-limiting embodiment of a unified charging system that can provide instant loans is shown. System 100 is provided to enable payments using instant loans at an online shopping site. Initialization component 104 can be provided to receive an indication of a checkout at a shopping site 102. Initialization component 104 can also receive a selection of cash and credit accounts 108-112 affiliated with a virtual charging account 106 that will be used for payment at shopping site 102. Verification component 114 can be provided to determine whether or not the selected cash and credit accounts 108-112 have sufficient balance to make the payment. Loan component 116 can be provided to give a loan to make the payment to the shopping site 102 in case the verification component 114 determines that there is an insufficient balance.

Initialization component 104 can receive an indication that a checkout procedure has been initiated at shopping site 102. Shopping site 102 can be accessed via a web browser on a mobile device, through a client application on a mobile device, or via a web browser on a non-mobile device computer. After selecting items or services to purchase at the shopping site 102 and proceeding to the checkout screen, an indication can be sent to initialization component 104 to initiate a virtual charging account. Alternatively, the indication can be sent when the virtual charging account 106 is selected as a payment option at shopping site 102.

Virtual charging account 106 can be affiliated with cash and credit accounts 108-112. The cash and credit accounts 108-112 can include cash accounts, bank accounts, checking accounts, debit cards, credit cards and et cetera. The various accounts can be manually associated with the virtual charging account 106, or can be automatically linked.

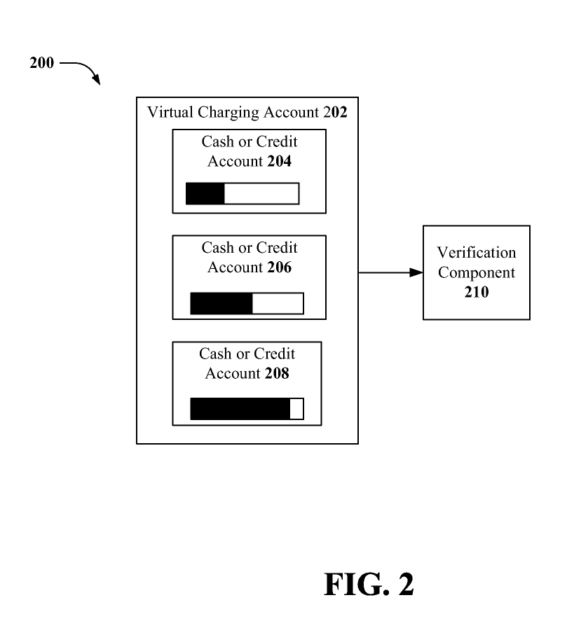

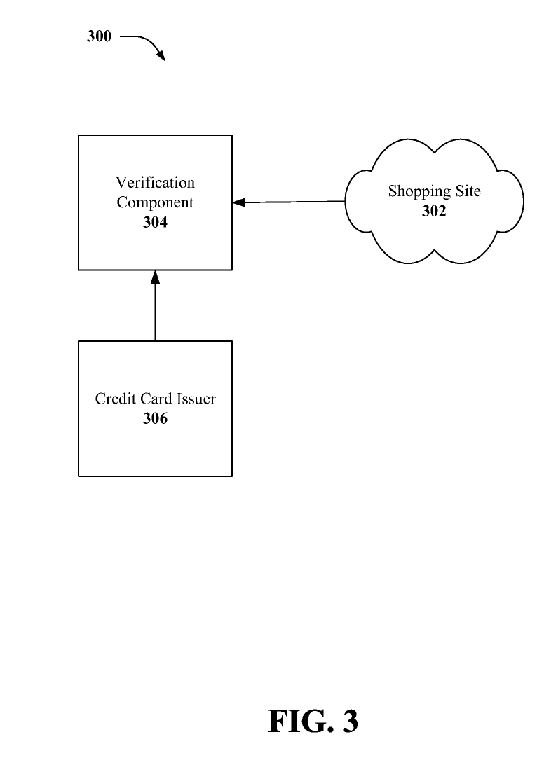

Once initialization component 104 receives the indication of the checkout, and receives a selection of at least one of the cash and credit accounts 108-112, initialization component 104 can forward that information to verification component 114. Verification component 114 can determine whether or not the selected cash and credit accounts 108-112 will have sufficient funds to make the payment. This determination can be based on the cash balance of the cash accounts, or based on the credit limit of the credit accounts. FIG. 2 and FIG. 3 show in more detail how verification component 114 determines whether a loan is necessary. If verification component 114 determines that there are sufficient funds to make the payment, then payment can proceed without using loan component 116.

Once verification component 114 determines that the selected cash and credit accounts 108-112 has an insufficient balance, verification component 114 will forward that information to loan component 116. In response to receiving that notification, loan component 116 can be configured to offer a loan to the virtual charging account to cover the payment, and pay the shopping site 102 with the loan.

In one embodiment, loan component 116 can automatically provide the loan in response to receiving notification that there are insufficient funds to cover the balance. In this embodiment, loan component 116 can automatically cancel the payment from the virtual charging card 106 to the shopping site 102, in order to avoid a rejected payment. Loan component 116 can then automatically and seamlessly provide the instant loan in lieu of the payment from the virtual charging account 106.

In another embodiment, loan component 116 can send a loan offer to the virtual charging account. If the loan offer is rejected, the proposed payment from the virtual charging account 106 is cancelled, and no further action occurs. Alternatively, if the loan offer is rejected, the payment can still go forward even if it will end up being rejected by the credit card issuer or the shopping site 102. If the loan component 116 receives an acceptance of the loan offer however, the loan component 116 can substitute the loan in lieu of the payment from the virtual charging account 106, allowing the payment to proceed at the shopping site 102.

In a still further embodiment, the loan component 116 can be configured to cancel the proposed payment, and provide a loan that covers the entire payment to the shopping site 102. In another embodiment, loan component 116 can supplement the payment from the virtual charging account 106 with a loan that covers the shortfall in payment.

In another embodiment, when payments are made from the virtual charging account 106, the payment can be anonymized so that the payee cannot learn the identity of the payer. A temporary charging account identity, or a pseudo-identity, can take the place of the payer's identity to anonymize the payment.

Turning now to FIG. 2, a block diagram illustrating an example, non-limiting embodiment of a system that checks the balance and credit limits of cash and credit accounts associated with a virtual charging account is shown. Virtual charging account 202 can be provided with associated cash or credit accounts 204, 206, and 208. Verification component 210 can be provided to check the balance of each of cash or credit accounts 204-208.

In an embodiment, when verification component 210 receives an indication of a checkout forwarded from an initialization component (not shown), verification component 210 can be configured to check the balance of each of the cash or credit accounts associated with the virtual charging account 202. In an alternative embodiment, verification component 210 can keep a running tally of the balance of the cash or credit accounts 204-208. The running tally can be based on monitoring transactions from the virtual charging account.

Verification component 202 can have authorization information which gives it access to the cash or credit accounts 204-208. The authorization information can be pre-associated with the verification component 210, or alternatively, verification component 210 can request the information from virtual charging account 202.

Verification component 210 can monitor the balances of the cash accounts, and can also monitor the credit limits of the credit accounts. Based upon the checkout indication received from the initialization component, verification component 210 can determine whether the balances and credit limits of the cash and credit accounts respectively are sufficiently high enough for the payment at the shopping site to proceed. Upon determining that the virtual charging account has insufficient funds, verification component 210 can forward an indication of insufficient funds to a loan component (not shown).

Turning now to FIG. 3, a block diagram illustrating an example, non-limiting embodiment of a system that receives an indication of insufficient balance from a credit card issuer is shown. Verification component 304 can be provided to receive an indication of insufficient balance from either a shopping site 302 or a credit card issuer 306.

Verification component 304 can receive an indication of insufficient balance from the shopping site 302 after a payment has been attempted. If the virtual charging account attempts to make the payment, but it is rejected due to insufficient funds, verification component 304 can receive an indication of the failure and reason for it in order to initiate a loan component (not shown).

In another embodiment, verification component 304 can receive the indication of insufficient balance from a credit card issuer 306. The verification component 304 can receive the indication after the payment has been attempted and has been rejected by the credit card issuer 306. In another embodiment, verification component 304 can gather the details about the selected cash and credit accounts, and the pending payment, and query the credit card issuer 306 to determine whether the credit accounts are maxed out or have insufficient credit limits for the payment at the shopping site 302.

In other embodiments, the verification component 304 can also receive an indication from the credit card issuer 306 that the planned payment will not succeed for reasons other than insufficient funds. Such reasons can include suspected fraud and privacy concerns.

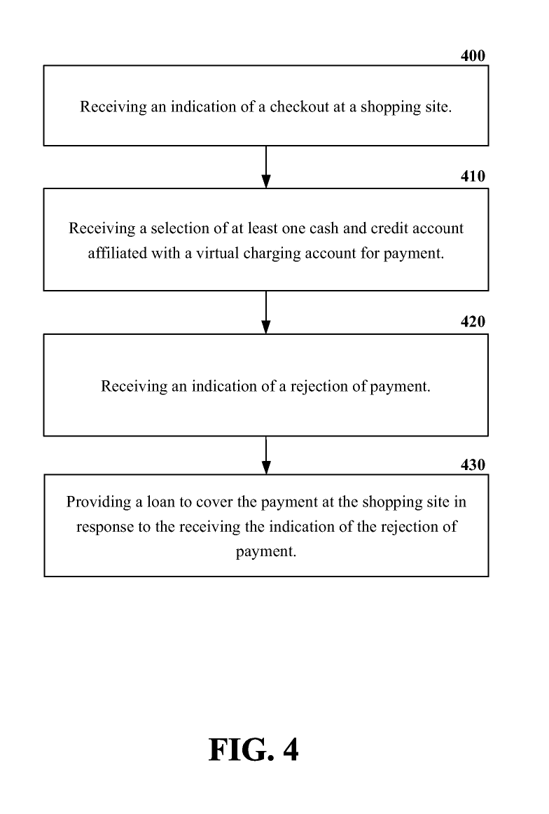

FIG. 4 illustrates a process in connection with the systems of FIG. 1-FIG. 3. The process in FIG. 4 can be implemented for example by systems 100, 200, or 300. FIG. 4 illustrates a flow diagram of an example, non-limiting embodiment of a method for providing an instant loan to cover a payment at a shopping site.

At 400, an indication of a checkout at a shopping site is received. The indication of a checkout can be received when the checkout screen at a shopping site is accessed or can be sent when the virtual charging account payment option is selected at the shopping site.

At 410, a selection of at least one cash and credit account for payment is received where the cash and credit accounts are affiliated with the virtual charging account. The selection can have been made manually or automatically. If made automatically, the selection could have been based on criteria such as a balance threshold, or whether a shopping site offers discounts if using certain types of cash or credit accounts. For instance, if a shopping site offers a discount if using a bank transfer, the cash account can be selected. The selecting of the cash or credit account can also be made automatically based on the cash or credit account with the highest remaining balance. Selecting the cash or credit account can also be made by manually entering an account number of the cash or credit account into the shopping site.

At 420, an indication of a rejection of payment can be received. The indication received can be that the selected cash and credit accounts have an insufficient balance to complete the transaction with the shopping site. The indication of rejection can also be for reasons such as suspected fraud.

In one embodiment, the indication can be received from the shopping site after the payment has been attempted. If the virtual charging account attempts to make the payment, but it is rejected due to insufficient funds, an indication of the failure and reason for it can be received.

In another embodiment, the indication of rejection can be received from a credit card issuer. The indication can be received after the payment has been attempted and has been rejected by the credit card issuer. In an alternative embodiment, the credit card issuer can be queried about whether the proposed payment would be successful, and receive an indication of rejection in response to the query about whether the credit accounts are maxed out or have insufficient credit limits for the payment at the shopping site.

At 420, a loan can be provided to cover the payment at the shopping site in response to receiving the indication of the rejection of the payment. The loan can be in lieu of the rejected payment, replacing it in full, or in the case of a shortfall in funds, the loan can supplement the rejected payment without replacing it.

In another embodiment, a loan offer can be sent to the virtual charging account. If the loan offer is rejected, the proposed payment is cancelled, and no further action occurs. If the loan offer is accepted however, the loan can be provided in response to receiving the acceptance of the offer.

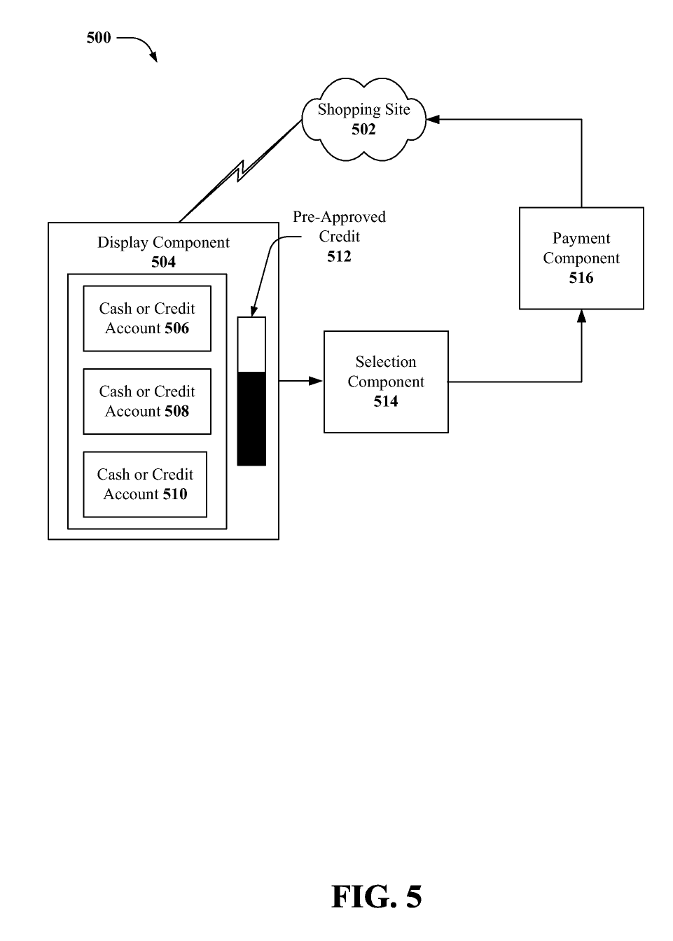

Turning now to FIG. 5, a block diagram illustrating an example, non-limiting embodiment of a system that can make a payment at a shopping site using linked cash or credit accounts and pre-approved credit is shown. System 500 can include display component 504 that is configured to display a list of cash or credit accounts and a pre-approved credit amount that is affiliated with a virtual charging account in response to reception of an indication of a checkout at shopping site 502. Display component 504 can include cash or credit accounts 506, 508, and 510, along with pre-approved credit 512. Selection component 514 can be provided to select at least one of the cash or credit accounts a portion of the pre-approved credit. Payment component 516 can be provided to pay a balance at the shopping site using the selected cash or credit account as well as the pre-approved credit 512.

Display component 504 can receive an indication that a checkout procedure has been initiated at shopping site 502. Shopping site 502 can be accessed via a web browser on a mobile device, through a client application on a mobile device, or via a web browser on a non-mobile device computer. After selecting items or services to purchase at the shopping site 502, and proceeding to the checkout screen, an indication can be sent to display component 504 to display a virtual charging account. Alternatively, the indication can be sent when the virtual charging account is selected as a payment option shopping site 502.

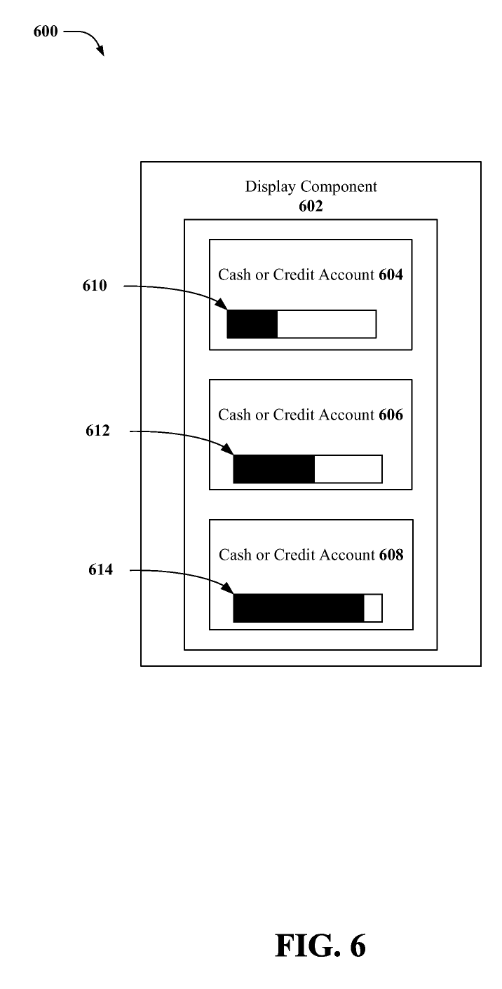

Display component 504 can display a list of affiliated cash and credit accounts 506-510. The list of cash and credit accounts 506-510 can be those that have previously been associated with the virtual charging account. Display component 504 can also display balances of each of the cash or credit accounts (shown in FIG. 6). Display component 504 can display the cash or credit accounts on the same page as the checkout screen, or display component 504 can display the list of accounts in a pop-up window.

Display component 504 can also display pre-approved credit 512. The pre-approved credit 512 can be associated with the user of the virtual charging account, and can be provided by the virtual charging account service in addition to the cash and credit accounts that are already linked. The pre-approved credit 512 can be credit that is determined by the virtual charging account service. In one embodiment, the pre-approved credit 512 can be granted upon a request for pre-approved credit 512. In another embodiment, the pre-approved credit 512 can be granted upon an analysis of open source information about the holder of the virtual charging account. Such information can include, but is not limited to, credit history, demographic information, occupational history, and so on. Higher amounts of pre-approved credit will be granted to low-risk users. Similarly, users that are high risk may receive very small portions of pre-approved credit, or none at all.

Selection component 514 can be used to select at least one of cash and credit accounts 506-510 to use for payment at the shopping site. Selection component 514 can select one of the cash or credit accounts displayed on the mobile device or non-mobile device at the shopping site page, or can select one of the cash or credit accounts displayed in the pop-up window.

In one embodiment, selection component 514 can automatically select a cash or credit account for payment based on the balance of the cash or credit accounts. Selection component 514 can select the cash or credit account with the highest balance, or can select from a set of cash or credit accounts with a balance above a defined threshold.

Selection component 514 can also select for payment a portion of the pre-approved credit 512. If it is determined that the cash or credit accounts 506-510 have an insufficient balance to make the payment at the shopping site 502, the selection component 514 can cover the shortfall with a portion of the pre-approved credit 512. In another embodiment, the selection component 514 can select solely the pre-approved credit 512 to make the payment.

Payment component 516 can be configured to pay the balance at the shopping site using the selected cash and credit accounts and the pre-approved credit. Payment component 516 can mask the identity of the cash or credit account used to pay the balance at the shopping site 502 by creating a temporary charging account identity. The temporary charging account identity can be used in lieu of a real identity so that the payment is made, and cannot be traced back to the cash or credit account selected.

Turning now to FIG. 6, a block diagram illustrating an example, non-limiting embodiment of a system 600 for displaying the balance of cash and credit accounts affiliated with a virtual charging account is shown. Display component 602 can display cash or credit accounts 604, 606, and 608 on a mobile device or on a non-mobile device. The display may be made in a pop-up window or on the same page as the checkout page at the shopping site. Balances 610, 612, and 614 can be shown alongside cash or credit accounts 604-608. Balances 610-614 can show the balance remaining for each of the cash or credit accounts. For instance, if account 604 is a bank account, the balance 610 can show the amount of funds in the bank account. If account 606 is a credit account, balance 612 can show the credit level and balance of account 606.

Display component 602 can access the accounts using authorization information that was received when the virtual charging account was created, in order to determine the balance of each of the cash or credit accounts.

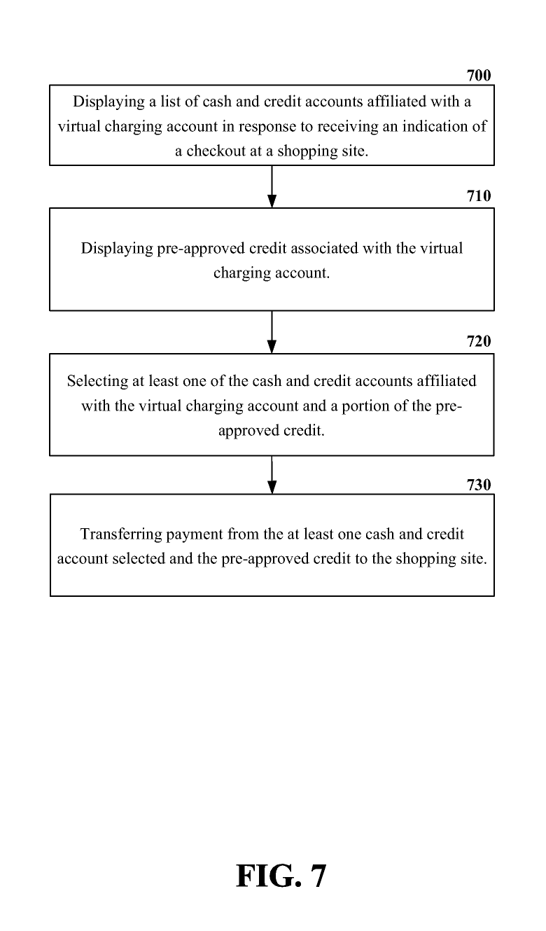

FIG. 7 illustrates a process in connection with systems 500 and 600 of FIG. 5 and FIG. 6 respectively. The process of FIG. 7 can be implemented for example by systems 500 and 600. FIG. 7 illustrates a flow diagram of an example, non-limiting embodiment of a method for shopping online and paying using a virtual charging account and pre-approved credit. At 700, a list of cash and credit accounts affiliated with a virtual charging account is displayed in response to receiving an indication of a checkout at a shopping site. The indication of a checkout can be received when the checkout screen at a shopping site is accessed or can be sent when the virtual charging account payment option is selected at the shopping site.

A list of cash and credit accounts affiliated with the virtual charging account can be displayed. A balance of each of the cash and credit accounts displayed can also be provided. The list of cash and credit accounts can be displayed on the checkout page of the shopping site, or can be displayed in a pop-up window.

At 710, pre-approved credit associated with the virtual charging account is also displayed. The pre-approved credit can be associated with the user of the virtual charging account, and can be provided by the virtual charging account service in addition to the cash and credit accounts that are already linked. The pre-approved credit can be credit that is determined by the virtual charging account service.

At 720, at least one of the cash and credit accounts affiliated with the virtual charging account and a portion of the pre-approved credit is selected. The selection can be made manually or automatically. If made automatically, the selection can be based on criteria such as a balance threshold, or whether a shopping site offers discounts if using certain types of cash or credit accounts.

A portion of the pre-approved can also be selected for payment at the shopping site. If it is determined that the cash or credit accounts have an insufficient balance to make the payment at the shopping site, a portion that covers the shortfall can be selected. In another embodiment, the pre-approved credit can cover the entire payment.

At 730, payment from the selected cash and credit accounts and pre-approved credit is transferred to the shopping site to pay the balance.

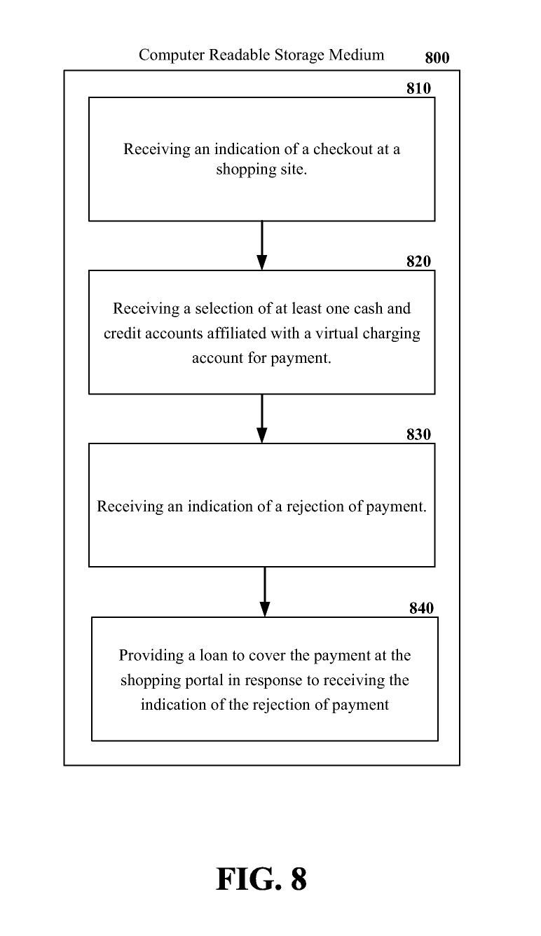

Turning now to FIG. 8, a flow diagram of an example, non-limiting embodiment of a set of computer-readable instructions for providing an instant loan to cover a payment at a shopping site is shown. Computer readable storage medium 800 can include computer executable instructions. At 810, these instructions can operate to receive an indication of a checkout at a shopping site. The indication of a checkout can be received when the checkout screen at a shopping site is accessed or can be sent when the virtual charging account payment option is selected at the shopping site.

At 820, these instructions can operate to receive a selection of at least one cash and credit accounts affiliated with a virtual charging account for payment. The selection can have been made manually or automatically. If made automatically, the selection could have been based on criteria such as a balance threshold, or whether a shopping site offers discounts if using certain types of cash or credit accounts. For instance, if a shopping site offers a discount if using a bank transfer, the cash account can be selected. The selecting of the cash or credit account can also be made automatically based on the cash or credit account with the highest remaining balance. Selecting the cash or credit account can also be made by manually entering an account number of the cash or credit account into the shopping site.

At 830, these instructions can operate to receive an indication of a rejection of payment. The indication received can be that the selected cash and credit accounts have an insufficient balance to complete the transaction with the shopping site. The indication of rejection can also be for reasons such as suspected fraud.

In one embodiment, the indication can be received from the shopping site after the payment has been attempted. If the virtual charging account attempts to make the payment, but it is rejected due to insufficient funds, an indication of the failure and reason for it can be received.

In another embodiment, the indication of rejection can be received from a credit card issuer. The indication can be received after the payment has been attempted and has been rejected by the credit card issuer. In an alternative embodiment, the credit card issuer can be queried about whether the proposed payment would be successful, and receive an indication of rejection in response to the query about whether the credit accounts are maxed out or have insufficient credit limits for the payment at the shopping site.

At 840, these instructions can operate to provide a loan to cover the payment at the shopping site in response to receiving the indication of the rejection of payment. The loan can be in lieu of the rejected payment, replacing it in full, or in the case of a shortfall in funds, the loan can supplement the rejected payment without replacing it.

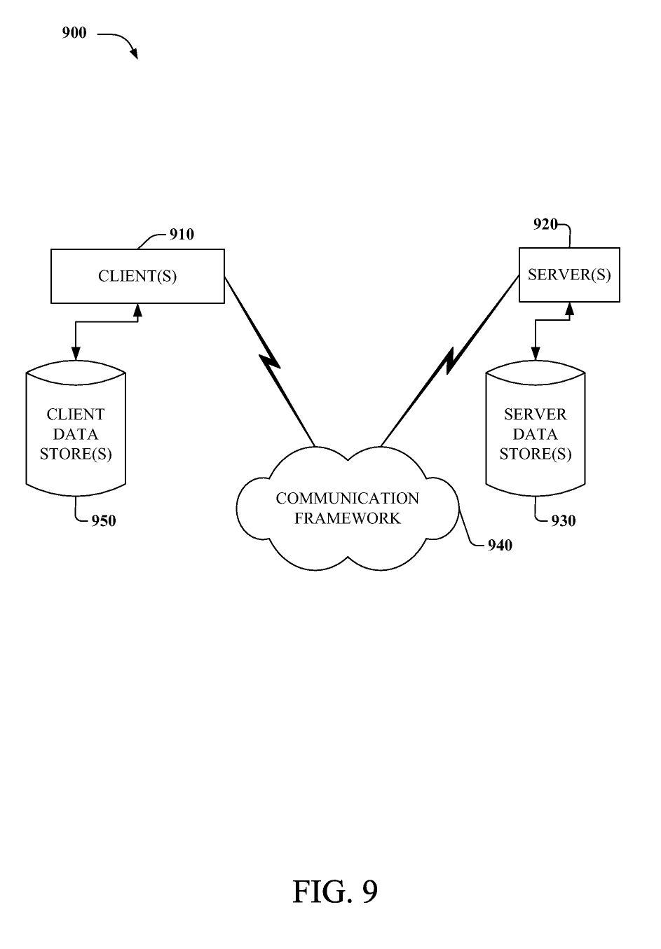

Turning now to FIG. 9 a block diagram illustrating an example networking environment that can be employed in accordance with the claimed subject matter is shown. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

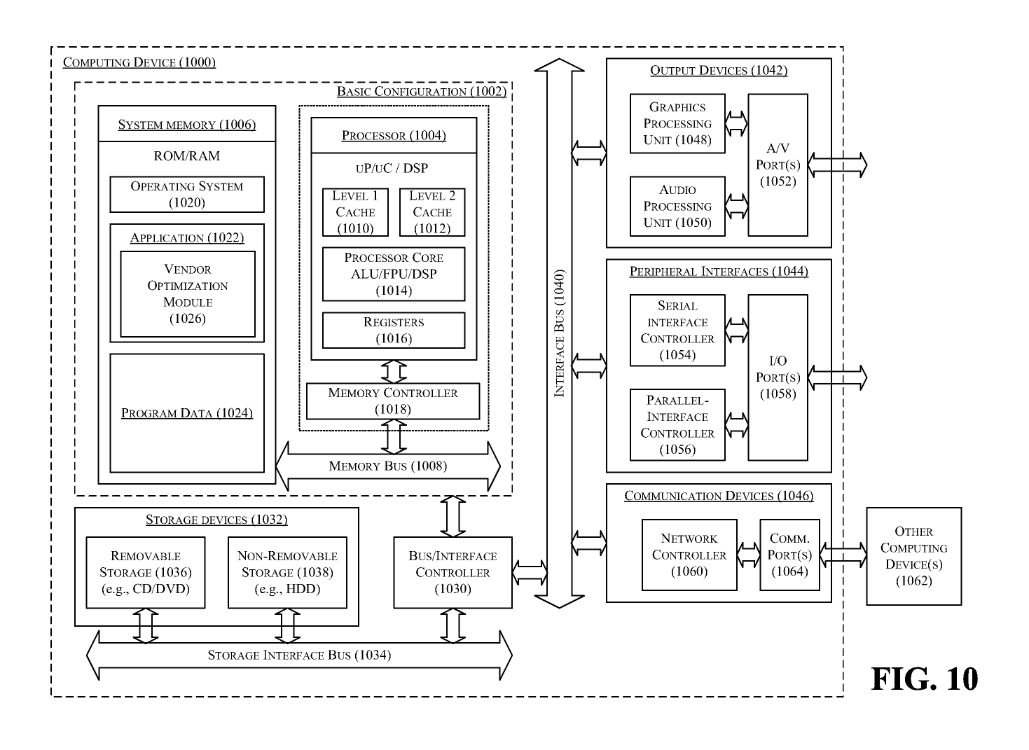

Referring now to FIG. 10, there is illustrated a block diagram of a computer operable to provide networking and communication capabilities between a wired or wireless communication network and a server and/or communication device. In order to provide additional context for various aspects thereof, FIG. 10 and the following discussion are intended to provide a brief, general description of a suitable computing environment 1300 in which the various aspects of the innovation can be implemented. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the exemplary environment 1000 for implementing various aspects includes a computer 1002, the computer 1302 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1011 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is to be appreciated that the innovation can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 2394 serial port, a game port, a USB port, an IR interface, etc.

A monitor 1044 or other type of display device is also connected to the system bus 1008 through an interface, such as a video adapter 1046. In addition to the monitor 1044, a computer typically includes other peripheral output devices (not shown), such as speakers, printers, etc.

The computer 1002 can operate in a networked environment using logical connections by wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 through the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least wireless fidelity (WiFi) and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

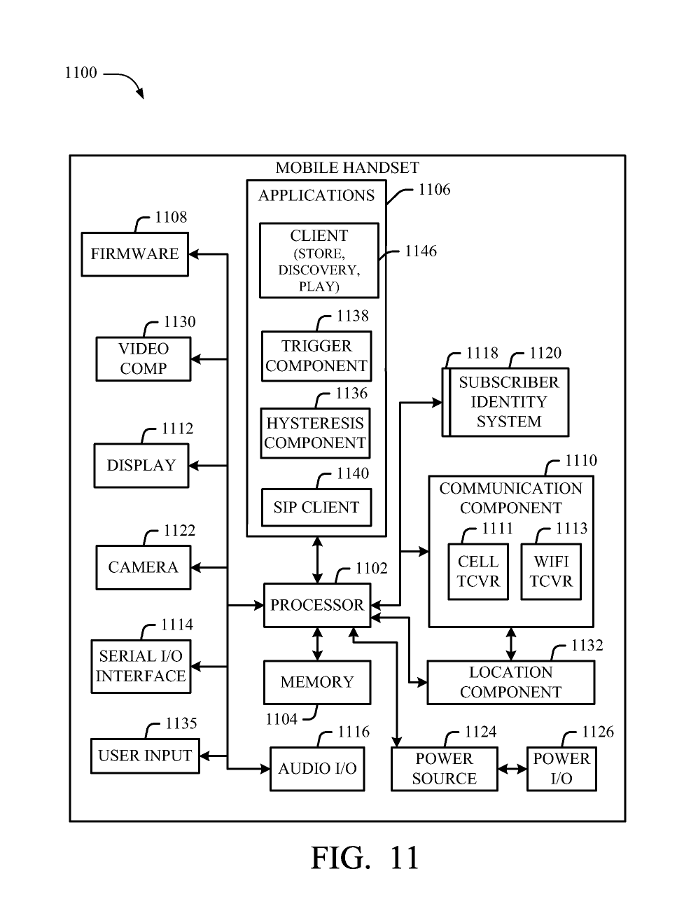

FIG. 11 illustrates a schematic block diagram of an exemplary device 1100 capable of employing the subject system in accordance with some embodiments of the invention. The device is a mobile handset 1100 In order to provide additional context for various aspects thereof, FIG. 11 and the following discussion are intended to provide a brief, general description of a suitable environment 1100 in which the various aspects can be implemented. While the description includes a general context of computer-executable instructions, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the inventive methods can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1100 includes a processor 1102 for controlling and processing all onboard operations and functions. A memory 1104 interfaces to the processor 1102 for storage of data and one or more applications 1106 (e.g., a video player software, user feedback component software, . . . ). Other applications can include voice recognition of predetermined voice commands that facilitate initiation of the user feedback signals. The applications 1106 can be stored in the memory 1104 and/or in a firmware 1108, and executed by the processor 1102 from either or both the memory 1104 or/and the firmware 1108. The firmware 1108 can also store startup code for execution in initializing the handset 1100. A communications component 1110 interfaces to the processor 1102 to facilitate wired/wireless communication with external systems, e.g., cellular networks, VoIP networks, and so on. Here, the communications component 1110 can also include a suitable cellular transceiver 1111 (e.g., a GSM transceiver) and an unlicensed transceiver 1113 (e.g., WiFi, WiMax) for corresponding signal communications. The handset 1100 can be a device such as a cellular telephone, a PDA with mobile communications capabilities, and messaging-centric devices. The communications component 1110 also facilitates communications reception from terrestrial radio networks (e.g., broadcast), digital satellite radio networks, and Internet-based radio services networks.

The handset 1100 includes a display 1112 for displaying text, images, video, telephony functions (e.g., a Caller ID function), setup functions, and for user input. The display 1112 can also accommodate the presentation of multimedia content (e.g., music metadata, messages, wallpaper, graphics, . . . ). A serial I/O interface 1114 is provided in communication with the processor 1102 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

The handset 1100 can include a slot interface 1118 for accommodating a SIC (Subscriber Identity Component) in the form factor of a card Subscriber Identity Module (SIM) or universal SIM 1120, and interfacing the SIM card 1120 with the processor 1102. However, it is to be appreciated that the SIM card 1120 can be manufactured into the handset 1100, and updated by downloading data and software thereto.

The handset 1100 can process IP data traffic through the communication component 1110 to accommodate IP traffic from an IP network such as, for example, the Internet, a corporate intranet, a home network, a person area network, etc., through an ISP or broadband cable provider. Thus, VoIP traffic can be utilized by the handset 1100 and IP-based multimedia content can be received in either an encoded or decoded format.

A video processing component 1122 (e.g., a camera) can be provided for decoding encoded multimedia content. The handset 1100 also includes a power source 1124 in the form of batteries and/or an AC power subsystem, which power source 1124 can interface to an external power system or charging equipment (not shown) by a power I/O component 1126.

The handset 1100 can also include a video component 1130 for processing video content received and, for recording and transmitting video content. A location tracking component 1132 facilitates geographically locating the handset 1100. As described hereinabove, this can occur when the user initiates the feedback signal automatically or manually. A user input component 1134 facilitates the user initiating the quality feedback signal. The input component can include such conventional input device technologies such as a keypad, keyboard, mouse, stylus pen, and touch screen, for example.

Referring again to the applications 1106, a hysteresis component 1136 facilitates the analysis and processing of hysteresis data, which is utilized to determine when to associate with the access point. A software trigger component 1138 can be provided that facilitates triggering of the hysteresis component 1138 when the WiFi transceiver 1113 detects the beacon of the access point. A SIP client 1140 enables the handset 1100 to support SIP protocols and register the subscriber with the SIP registrar server. The applications 1106 can also include a client 1142 that provides at least the capability of discovery, play and store of multimedia content, for example, music.

The handset 1100, as indicated above related to the communications component 1110, includes an indoor network radio transceiver 1113 (e.g., WiFi transceiver). This function supports the indoor radio link, such as IEEE 802.11, for the dual-mode GSM handset 1100. The handset 1100 can accommodate at least satellite radio services through a handset that can combine wireless voice and digital radio chipsets into a single handheld device.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
receiving, by a system comprising a processor, an indication of a checkout at a shopping site;
receiving, by the system, a selection of at least one cash and credit account affiliated with a virtual charging account for payment;
receiving, by the system, an indication of a rejection of payment;
determining, by the system, a credit limit based on a loan repayment risk factor; and
providing, by the system, a loan to cover the payment at the shopping site in response to the receiving the indication of the rejection of payment, wherein an amount of the loan is lower than the credit limit.

2. The method of claim 1, further comprising receiving, by the system, an indication the at least one cash and credit account has insufficient funds for the payment.

3. The method of claim 1, further comprising receiving, by the system, an indication the at least one cash and credit account has exceeded a credit limit.

4. The method of claim 1, further comprising providing, by the system, funds to cover a shortfall of the at least one cash and credit account.

5. The method of claim 1, further comprising providing, by the system, funds to cover all of the payment.

6. The method of claim 1, further comprising providing, by the system, the loan in response to receiving an indication of an acceptance of the loan.

7. The method of claim 1, further comprising generating, by the system, a temporary charging account identity for transferring the payment.

8. A system, comprising:
a memory storing computer-executable instructions; and
a processor, communicatively coupled to the memory, which facilitates execution of the computer-executable instructions to at least:
receive an indication of a checkout at a shopping site and a selection of at least one cash and credit accounts affiliated with a virtual charging account for payment at the shopping site;
determine that the at least one cash and credit account has an insufficient balance to make the payment;
determine a pre-approved credit amount based on a financial indicator associated with the virtual charging account; and
provide a loan to make the payment at the shopping site in response to the insufficient balance in response to a difference between a balance of the at least one cash and credit account and the payment being determined to be less than the pre-approved credit amount.

9. The system of claim 8, wherein the processor further facilitates the execution of the computer-executable instructions to:
receive the indication of a checkout in response to a selection of the virtual charging account at the shopping site.

10. The system of claim 8, wherein processor further facilitates the execution of the computer-executable instructions to:
check a balance of the at least one cash and credit account.

11. The system of claim 8, wherein processor further facilitates the execution of the computer-executable instructions to:
receive an indication of insufficient balance from at least one of a credit card issuer and the shopping site.

12. The system of claim 8, wherein processor further facilitates the execution of the computer-executable instructions to:
provide a loan to cover a shortfall of the at least one cash and credit account.

13. The system of claim 8, wherein processor further facilitates the execution of the computer-executable instructions to:
provide a loan to cover all of the payment.

14. The system of claim 8, wherein processor further facilitates the execution of the computer-executable instructions to:
provide the loan in response to receipt of an acceptance of a loan offer.

15. A tangible computer readable storage medium comprising computer executable instructions that, in response to execution, cause a computing system to perform operations, comprising:
receiving an indication of a checkout at a shopping site;
receiving a selection of at least one cash and credit accounts affiliated with a virtual charging account for payment;
receiving an indication of a rejection of payment;
calculating a credit limit based on a financial indicator associated with loan repayment risk; and
providing a loan to cover the payment at the shopping site if the loan is lower in value than the credit limit in response to receiving the indication of the rejection of payment.

16. A method, comprising:
displaying, by a system comprising a processor, a list of cash and credit accounts affiliated with a virtual charging account in response to receiving an indication of a checkout at a shopping site;
calculate pre-approved credit based on a financial indicator associated with the virtual charging account;
displaying, by the system, the pre-approved credit associated with the virtual charging account;
selecting, by the system, at least one of the cash and credit accounts affiliated with the virtual charging account and a portion of the pre-approved credit; and
transferring, by the system, payment from the at least one cash and credit accounts and the pre-approved credit to the shopping site.

17. The method of claim 16, further comprising displaying, by the system, a balance of the cash and credit accounts.

18. The method of claim 16, further comprising displaying, by the system, the list of the cash and credit accounts and the pre-approved credit in a pop-up window.

19. The method of claim 16, further comprising providing, by the system, the pre-approved credit in response to receiving a request for credit.

20. The method of claim 16, further comprising determining, by the system, the pre-approved credit in response to analyzing open source information associated with a holder of the virtual charging account.

21. The method of claim 1, further comprising transferring, by the system, all of the payment from pre-approved credit.

22. The method of claim 1, further comprising transferring, by the system, a portion of the payment from pre-approved credit, and another portion of the payment from the at least one cash and credit accounts.

23. A system, comprising:
a memory to store computer-executable instructions; and
a processor, communicatively coupled to the memory, which facilitates execution of the computer-executable instructions to at least:
display a list of cash and credit accounts and pre-approved credit affiliated with a virtual charging account in response to reception of an indication of a checkout at a shopping site, wherein the pre-approved credit is determined based on an analysis of a loan repayment risk factor;
select at least one of the cash and credit accounts and a portion of the pre-approved credit affiliated with the virtual charging account; and
pay a balance at the shopping site using the at least one cash and credit accounts and the pre-approved credit in response to the balance being less than a balance of the at least one cash and credit account and the pre-approved credit.

24. The system of claim 23, wherein the processor further facilitates the execution of the computer-executable instructions to:
display a balance of each of the list of cash and credit accounts.

25. The system of claim 23, wherein the processor further facilitates the execution of the computer-executable instructions to:
open a pop-up window to display the list of cash and credit accounts and the pre-approved credit.

26. The system of claim 23, wherein the pre-approved credit is provided in response to a request for pre-approved credit.

27. The system of claim 23, wherein the pre-approved credit is provided in response to an analysis of open source information associated with a holder of the virtual charging account.

28. The system of claim 23, wherein the processor further facilitates the execution of the computer-executable instructions to:
select all only the pre-approved credit for the payment.

29. The system of claim 23, wherein the processor further facilitates the execution of the computer-executable instructions to:
select a portion of the payment from the pre-approved credit, and another portion of the payment from the at least one cash and credit accounts.
